(19) United States
(12) Patent Application Publication
(10) Pub. No.: US 2003/0059514 A1
(43) Pub. Date: Mar. 27, 2003

(54) Compositions comprising soy protein and processes of their preparation

(76) Inventors: Francisco Valentino Villagran, Mason, OH (US); John Michael Baughman, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/950,900

(22) Filed: Sep. 10, 2001

(51) Int. Cl. C12C 1/00

(52) U.S. Cl. 426/590

(57) ABSTRACT

The present disclosure describes compositions having an improved creamy mouthfeel and the health benefits of soy protein. Further described are compositions comprising soy protein particles having a mean particle size distribution of from about 0.1 to about 10 microns, wherein the compositions are substantially free of fat. Other described compositions are those comprising soy protein particles having a mean particle size distribution of from about 0.1 to about 10 microns; and having a pH of from about 6 to about 8 or, alternatively, from about 2.5 to about 3.5.

The disclosure further relates a process for producing a composition comprising soy protein particles, comprising the steps of:

a) providing a mixture of a soy protein and an aqueous liquid, wherein the pH of the mixture is at least about 11;

b) lowering the pH of the mixture to a pH of from about 6 to about 8 and applying mechanical energy to the mixture;

wherein when the pH of the mixture is greater than about 8 the temperature of the mixture is at about 20° C. or less; and wherein the soy protein particles have a mean particle size distribution of from about 0.1 to about 10 microns.

### FIELD OF THE INVENTION

The present invention relates to compositions comprising soy protein which may be used in food or beverage products, and processes for making such compositions.

### BACKGROUND OF THE INVENTION

In recent years, the discovery of health benefits associated with soy products has steadily increased. Most recently, the U.S. Food and Drug Administration (FDA) has announced its approval of a health claim which states that consumption of soy protein, in conjunction with a diet low in saturated fat and cholesterol, can reduce the risk of coronary heart disease, which is the number one cause of death in the United States. For a product to qualify for the health claim of soy protein, each serving of the product must contain at least 6.25 grams of soy protein, or one-fourth of the 25 gram amount shown to produce a cholesterol-lowering effect.

Moreover, studies indicate that regular consumption of soy protein can help reduce the likelihood of the development of some cancers, including breast cancer. See Medical Industry Today, “Soy Protein Gains Heart Health Claim from FDA,” Oct. 22, 1999.

With the discovery of the many health benefits associated with soy protein, a variety of food and beverage manufacturers have attempted to produce soy protein products that are appealing to consumers. Key factors leading to the difficulty in increasing consumption of soy protein products by consumers include the undesired organoleptic characteristics associated with such products, such as the unpleasant bean-like flavor and odor associated with the soy protein itself, as well as the gritty texture of the soy protein.

Manufacturers have used a variety of methods in attempts to optimize processing associated with soy protein. For example, many processes currently available for producing soy protein products useful in food and beverage products generally utilize high temperature in conjunction with low pH environments to denature the protein and obtain the desired soy protein product. Typically, the resulting product is a soluble soy protein in water or an insoluble precipitate, such as a protein curd. See e.g. U.S. Pat. No. 3,653,912, Koski et al., issued Apr. 4, 1972; U.S. Pat. No. 3,995,071, Goodnight et al. issued Nov. 30, 1976; U.S. Pat. No. 5,798,446, Neumuller, issued Aug. 25, 1998; and U.S. Pat. No. 6,013,771, Shen et al., issued Jan. 11, 2000. However, currently marketed soy products containing large soy protein particles result in the aforementioned unpleasant flavor, odor and texture commonly associated with soy. Additionally, products having solublized soy protein often lack the creaminess and texture desired by the consumer.

In addition, manufacturers seeking to improve the “mouthfeel” of soy protein products add fat to stabilize the protein and prevent the protein from sedimenting or precipitating out of the product. “Mouthfeel” relates generally to tactile impressions, which are particularly perceived in the mouth and throat. More specifically, the term “mouthfeel” as used herein, is associated with the tactile perception of fineness, coarseness, and smoothness.

However, while this addition of fat helps prevent precipitation and achieve the desired creamy mouthfeel, it also adds fat to the consumer's diet. See e.g. U.S. Pat. No. 3,639,129, Mustakas et al. issued Feb. 1, 1972. While some consumers may not find this disadvantageous, many health conscious consumers will.

As has been discovered herein, the present invention provides soy protein in a highly stable dispersion without reliance on fat. Accordingly, while the present invention may optionally contain fat, a particularly preferred embodiment of the present invention provides soy protein dispersions for use in beverage compositions that are substantially free of fat. In accordance with the present invention, therefore, beverage compositions are provided which may have varying levels of fat (or none at all), depending upon the desires of the consumer.

As has been discovered herein, but without being limited by theory, the present inventor believes that the aforementioned unpleasant flavor, odor, and texture relates largely to the size of the soy protein particles in the product. In contrast to the current technology, the present invention relates to compositions comprising soy protein microparticles that are small enough to eliminate the “beany” flavor, odor, and gritty texture associated with soy protein, and small enough to remain in a dispersion that provides the consumer with the desired creamy mouthfeel and the health benefits of soy.

Accordingly, the present invention provides a soy protein composition for use in beverage compositions, which has an improved creamy mouthfeel and the health benefits of soy protein. As particularly advantageous, the present compositions may be optionally free of fat. Moreover, significant amounts of soy protein may be included, for example, those amounts which satisfy the current FDA health claim.

### SUMMARY OF THE INVENTION

The present invention relates to compositions having an improved creamy mouthfeel and the health benefits of soy protein. An optional, and preferred embodiment of the present invention, relates to compositions comprising soy protein particles having a mean particle size distribution of from about 0.1 to about 10 microns, wherein the compositions are substantially free of fat. Additionally, the present invention relates to a compositions comprising soy protein particles having a mean particle size distribution of from about 0.1 to about 10 microns; and having a pH of from about 6 to about 8 or, alternatively, from about 2.5 to about 3.5.

The present invention further relates to a process for producing a composition comprising soy protein particles, comprising the steps of:

a) providing a mixture of a soy protein and an aqueous liquid, wherein the pH of the mixture is at least about 11;

b) lowering the pH of the mixture to a pH of from about 6 to about 8 and applying mechanical energy to the mixture;

wherein when the pH of the mixture is greater than about 8 the temperature of the mixture is at about 20° C. or less; and wherein the soy protein particles have a mean particle size distribution of from about 0.1 to about 10 microns.

The present invention further relates to compositions prepared by the foregoing process.

### DETAILED DESCRIPTION OF THE INVENTION

The present invention relates to soy protein compositions which may be utilized in foods and beverages. These compositions and processes of their preparation provide products having an improved creamy mouthfeel and the health benefits of soy protein.

Publications and patents are referred to throughout this disclosure. All references cited herein are hereby incorporated by reference.

All percentages and ratios are calculated by weight unless otherwise indicated. All percentages and ratios are calculated based on the total composition unless otherwise indicated.

All component or composition levels are in reference to the active level of that component or composition, and are exclusive of impurities, for example, residual solvents or by-products, which may be present in commercially available sources.

Referred to herein are trade names for components including various ingredients utilized in the present invention. The inventors herein do not intend to be limited by materials under a certain trade name. Equivalent materials (e.g., those obtained from a different source under a different name or reference number) to those referenced by trade name may be substituted and utilized in the methods herein.

In the description of the invention various embodiments and/or individual features are disclosed. As will be apparent to the ordinarily skilled practitioner, all combinations of such embodiments and features are possible and can result in preferred executions of the present invention.

The compositions herein may comprise, consist essentially of, or consist of any of the elements as described herein.

### Compositions of the Present Invention

The present invention relates to compositions comprising soy protein which provide enhanced organoleptic properties relative to known soy products, particularly with respect to flavor, odor, and mouthfeel. In particular, the present invention relates to several embodiments which are each discussed in detail herein.

Soy protein is commonly known in the art and may be in the form of, for example, soy protein isolate, soy protein concentrate, and/or soy flour. For example, soy flour may be produced from ground soybeans after removal of oil and typically contains at least about 50% protein, by weight of the soy flour. Soy protein concentrate is further refined through the removal of most non-protein components, and typically contains at least about 65% protein, by weight of the soy protein concentrate. Soy protein isolate is the most preferred soy protein form utilized herein due to its high protein content. For example, soy protein isolate typically comprises at least about 70% soy protein and most preferably at least about 90% soy protein, by weight of the soy protein isolate. All of these forms may contain isoflavones and phytosterols, which have been associated with various health benefits such as serum cholesterol reduction, cancer prevention, and improvement of hormonal imbalance.

In each of the embodiments described herein, the inventive compositions comprise soy protein having a defined mean particle size distribution. As has been discovered herein, use of soy protein particles having this defined mean particle size distribution within the compositions significantly reduces the bean-like flavor and odor and enhances the mouthfeel of the compositions. Moreover, as has been discovered herein, wherein the compositions are of an aqueous nature, use of soy protein particles having such mean particle size distribution prevents or inhibits the particles from sedimenting or precipitating out of the aqueous liquid. Maintenance of the particles within a dispersion provides the foregoing enhanced organoleptic properties and further enhances proper dose delivery of the soy protein itself. Accordingly, use of such mean particle size distribution improves all aspects of the final soy protein composition.

The compositions herein may be of various forms. For example, the compositions may be used in or as food or beverage products, or may be used to supply food or beverage manufacturers (i.e., as a substantially dry soy protein composition or a soy dispersion in aqueous liquid) with proper starting materials such that acceptable food or beverage products may be formulated. As used herein, the term “substantially dry” with reference to a given composition means that the composition comprises less than about 5% water, more preferably less than about 3% water, and most preferably less than about 2% water, all by weight of the composition. Non-limiting examples of preferred product forms include health bars, breads, ice cream, and the like, or even starting materials for use in further formulation of food or beverage products. Additionally, the compositions may be ready-to-drink beverages or beverage concentrates. Non-limiting examples of optional components suitable for formulating these various forms are described below.

As has been discovered herein, the present inventive compositions comprise soy protein particles having a mean particle size distribution of from about 0.1 to about 10 microns. Preferably, the compositions comprise soy protein particles having a mean particle size distribution of from about 0.1 to about 7 microns, and most preferably from about 0.1 to about 5 microns. As used herein, and as will be commonly understood in the art, the term “mean particle size distribution,” with reference to the soy protein particles, is the mean value of the soy protein particles present in the composition based on the particle sizes of the individual soy protein particles in the composition. The mean particle size distribution of the protein particles of the present invention may be measured using a HORIBA LA-910 laser scattering particle size distribution analyzer, or other instrument providing substantially similar results.

The compositions herein may comprise various levels of soy protein. In particular, the invention enables inclusion of high levels of soy protein content, particularly through the defined mean particle size distributions and enhanced by the processes of preparation described herein. Preferably, the compositions comprise no more than about 15% soy protein and more preferably no more than about 10% soy protein, all by weight of the composition. Alternatively, relatively low levels of soy protein may be included, for example, no more than about 5% soy protein or no more than about 2% soy protein, all by weight of the composition. Alternatively or additionally, the present invention relates to inclusion of soy protein levels which enable labeling of the U.S. FDA soy protein heart health claim, i.e., at least about 6.25 grams of soy protein per single serving of the composition, wherein the single serving is preferably at least about 50 grams, more preferably at least about 100 grams. For beverage compositions, the single serving is even more preferably at least about 200 grams.

The various embodiments of the present invention are now described in detail, as follows. These embodiments are referred to as the “first embodiment,” “second embodiment,” or the like. However, these references are used only for purposes of convenience and should not be construed as, for example, indicating relative importance of any given embodiment.

First Embodiment of the Present Invention

One embodiment of the present invention relates to soy protein compositions comprising soy protein particles having a mean particle size distribution of from about 0.1 to about 10 microns, wherein the composition is substantially free of fat. It is particularly surprising that compositions comprising soy protein can be made substantially free of fat. Indeed, known food and beverage compositions containing soy protein, particularly aqueous beverages, currently include fat as a means to stabilize the soy protein and prevent such protein from sedimenting or precipitating out of solution. This is achieved through absorption of the protein at the water-fat interface, essentially leading to emulsification. As has been discovered herein, this emulsification and inclusion of fat is surprisingly unnecessary wherein the compositions comprise soy protein particles having the defined mean particle size distribution as set forth above.

By “substantially free of fat,” it is meant that the composition comprises less than about 1% total fat, preferably less than about 0.75% total fat, even more preferably less than about 0.5% total fat, and most preferably about 0% fat, all by weight of the composition. What constitutes fat is well known to those ordinarily skilled in the art; indeed fat calculations are regularly calculated and conveyed on labeling information for most foods and beverages.

Further preferred variations on this described embodiment are as set forth throughout the description herein, for example preferred forms of the composition (e.g., food or beverage, substantially dry or ready-to-drink), preferred soy protein content, preferred mean particle size distributions, preferred pH limitations, and additional optional components and levels thereof.

Second and Third Embodiments of the Present Invention

Another embodiment of the present invention relates to soy protein compositions comprising soy protein particles having a mean particle size distribution of from about 0.1 to about 10 microns; wherein the pH of the composition is from about 6 to about 8, more preferably from about 6 to about 7, and most preferably from about 6.5 to about 7. In yet another embodiment of the present invention, soy protein compositions are provided which comprise soy protein particles having a mean particle size distribution of from about 0.1 to about 10 microns; wherein the pH of the composition is from about 2.5 to about 3.5.

With respect to these embodiments, it has been discovered that certain pH ranges provide optimal stability of the soy protein, particularly as a dispersion in an aqueous liquid. In particular, it has been discovered that slightly acidic to slightly basic compositions may be utilized (i.e., pH from about 6 to about 8). However, wherein the pH is below about 6, optimal stabilization is not achieved unless, quite surprisingly, the pH is from about 2.5 to about 3.5. Accordingly, the present invention is particularly useful for slightly acidic to slightly basic compositions (e.g., dairy compositions, sports beverages or water beverages) or highly acidic compositions (e.g., fruit juice compositions). The present compositions are therefore quite adaptable to a variety of final compositions, depending upon the needs of the consumer.

Again, further preferred variations within these described embodiments are as set forth throughout the description herein, for example preferred forms of the composition (e.g., food or beverage, substantially dry or ready-to-drink), preferred soy protein content, preferred mean particle size distributions, and additional optional components and levels thereof. Additionally, such variations may also be substantially free of fat, as described above for the first embodiment.

Fourth Embodiment of the Present Invention

As yet another embodiment herein, the present inventors have discovered a process for use in preparing optimal compositions herein. This embodiment relates to such processes and compositions which are produced by this process. Moreover, the foregoing embodiments described herein may optionally, and preferably, be prepared by this described process.

In the present inventive process, compositions comprising soy protein particles are prepared, comprising the steps of:

a) providing a mixture of a soy protein and an aqueous liquid, wherein the pH of the mixture is at least about 11; and

b) lowering the pH of the mixture to a pH of from about 6 to about 8 and applying mechanical energy to the mixture;

wherein when the pH of the mixture is greater than about 8 the temperature of the mixture is at about 20° C. or less; and wherein the soy protein particles have a mean particle size distribution of from about 0.1 to about 10 microns.

The first step of the process involves providing a mixture of the soy protein and an aqueous liquid (preferably, water), wherein the pH of the mixture is at least about 11 and most preferably at least about 12. Without intending to be limited by theory, it is believed that this step is important for untangling the various protein molecules such that the molecules can be reconfigured further in the process from a particle size standpoint. It is further believed that the limitations on this step are important for eliminating undesirable chemical changes in the structure of the protein that occur at temperatures higher than about 20° C. when the pH is higher than about 10. For example, at higher temperatures, the protein can degrade and hydrolyze to produce sulfur compounds which impart an egg-like aroma and flavor.

The preferred method for carrying out this first step is mixing the soy protein and the aqueous liquid and then adding an alkaline material to the mixture in an amount sufficient to raise the pH of the mixture to at least about 11, and most preferably to at least about 12. As an alternate preferred method, the alkaline material can be added to the aqueous liquid in an amount sufficient to achieve the desired pH, followed by addition of the soy protein. The mixture is preferably stirred by conventional methods as the pH is raised. Any alkaline material known in the art suitable for this process may be employed, however, food grade alkaline materials are preferred. For example, preferred alkaline materials which may be utilized include potassium hydroxide, sodium hydroxide, calcium hydroxide, dipotassium phosphate, disodium phosphate, sodium carbonate, sodium bicarbonate, magnesium carbonate, and mixtures thereof.

Once the soy protein is included in the mixture during this step, it is important that the temperature of the mixture is less than about 20° C., more preferably about 15° C. or less, and most preferably about 10° C. or less. This is important since it will be highly preferable to avoid, or substantially avoid, hydrolysis and chemical degradation of the soy protein. Temperature may be maintained by a variety of known means, for example, contacting the mixing vessel with chilled water. More particularly, the chilled water may be used in commercial scale heat exchangers to maintain the temperature of the mixture.

The next step of the process is lowering the pH of the mixture to provide a pH of from about 6 to about 8, more preferably from about 6 to about 7, and most preferably from about 6.5 to about 7. Lowering the pH may be conducted by a variety of well-known means, including the addition of an acidic material to the mixture. Any acidic material known in the art suitable for this process may be employed, however, a food grade acidic material is highly preferred. For example, preferred acidic materials which may be utilized herein include phosphoric acid, acetic acid, lactic acid, citric acid, ascorbic acid, malic acid, tartaric acid, fumaric acid, succinic acid, and mixtures thereof. Without intending to be limited by theory, it is believed that this step, particularly when concurrently applying mechanical energy as described below, is important to prevent the protein from precipitating out of the aqueous liquid and forming very large particles or an insoluble curd-like precipitate.

As with the first step, it is important that the temperature of the mixture is maintained at about 20° C. or less, more preferably about 15° C. or less, and most preferably about 10° C. or less, until the pH of the mixture is less than about 8. However, it is also preferable to maintain this temperature throughout the steps of the process if the pH is lowered further to less than about 8. Of course, once below about 8, the composition may then be maintained at ambient temperature or otherwise, such as during formulation in a final food or beverage composition.

Application of the mechanical energy occurs during acidification of the mixture to a pH of from about 6 to about 8. Such application of mechanical energy may be performed during only a portion of the period of pH lowering, or constantly until the desired pH is achieved. Most preferably, the application of mechanical energy is constantly applied during this lowering of the pH of the mixture. Application of the mechanical energy is important to ensure that the defined mean particle size distribution, as described herein above, is achieved.

As used herein, the term “mechanical energy” means energy applied to a system by a device or apparatus with moving parts, whereby the moving parts can increase pressure of the fluid or subject it to shear forces. Various types of mechanical energy may be employed in this process, including, for example, high shear mixing, homogenization, colloid milling, and mixtures thereof.

As used herein, high shear mixing involves shear forces between layers of fluids or between fluids or solid (wall) devices wherein those fluid layers or fluid solid interfaces are moving at high speeds, thereby utilizing rotational force to break down particles into the defined size. In the present invention, high shear mixing is preferably applied at a rate of from about 100,000 1/seconds to about 750,000 1/seconds.

Homogenization generally utilizes pressure to break down the particles into the defined size. The mixture is forced through a homogenizer where the product is subjected to pressure that results in this break down. The resulting size of the particles varies with the amount of pressure applied, as will be well understood to those of ordinary skill in the art. Moreover, homogenization can be applied in either a single stage or a dual stage. In a single stage application, the dispersion is forced through a small opening by a single application of pressure. In a dual stage application, the dispersion is subjected two pressure applications. The purpose of this second pressure application is to further break down the particles in the dispersion. In the present invention, when single stage homogenization is utilized it is preferably applied in a single stage at a pressure of at least about 350 kg/cm² (kilograms per centimeter-squared). More preferably, when dual stage homogenization is utilized, it is applied at a pressure of less than about 420 kg/cm².

Colloid milling is similar to high shear, however, in this case the fluid is subjected to shear forces between two solid walls; one static (no movement) and the other one moving at high speed (rpm). The gap, referred to herein and commonly as the “gap,” between the static and moving solid wall can be adjusted to obtain a desired particle size distribution. In the present invention, colloid milling is preferably applied with a gap of from about 1 micron to about 20 microns.

The most preferred application of mechanical energy for use in the present process is a combination of high shear mixing and homogenization. For example, this combination can be performed in a continuous form in a manner that the fluid is in a tank being subjected to high shear mixing and then recirculated through a homogenizer operated at the target pressure and back to the tank or to a final tank for drying.

Once a pH of from about 6 to about 8 is achieved, and the soy protein particles have a particle size of from about 0.1 microns to about 10 microns, the composition may be utilized for a variety of applications. For example, the composition can be further formulated into food or beverage products by combining the composition with varying mixtures of the optional components described herein. Used in this way, the compositions can be used to formulate such items as ready to drink beverages, soups, and ice creams. Moreover, the composition can be subjected to a drying process that produces a substantially dry composition, for example “dry beverage compositions” (as used herein, “dry beverage compositions” are substantially dry (meaning, comprising from 0% to about 4%, preferably from 0% to about 3% water) compositions which are suitable for dilution with water or other liquids to form a concentrated or ready-to-drink beverage composition). Such a substantially dry compositions can be utilized as concentrated foods or beverages which can be readily reconstituted by the addition of an aqueous liquid such as water.

The processes described herein are particularly useful for preparing a wide variety of finished beverage compositions. Such beverage compositions include not only “traditional” beverages, but also those such as dietary supplements, and the like, under regulatory guidelines.

### Optional Components for Use in the Present Invention

Various optional ingredients may be added to the compositions to form the desired finished composition. Non-limiting examples of such optional ingredients are given below.

Such beverage compositions may optionally be dilute water beverages (also called “near-water” beverages), botanical beverages (e.g., coffees and teas), dairy beverages, juices, other flavored beverages, isotonic beverages.

Water

The compositions may comprise from 0% to about 99.999% water, by weight of the composition. Water is not necessary, but may be included, in dry beverage compositions (as used herein, “dry beverage compositions” are substantially dry (meaning, comprising from 0% to about 4%, preferably from 0% to about 3% water) compositions which are suitable for dilution with water or other liquids to form a concentrated or ready-to-drink beverage composition).

Beverage compositions which are not dry beverage compositions typically comprise at least about 4% water, preferably at least about 20% water, more preferably at least about 40% water, still more preferably at least about 50% water, even more preferably at least about 75% water, and most preferably at least about 80% water. Still further, ready-to-drink beverage compositions will typically comprise at least about 50% water. The water included at these levels includes all added water and any water present in combination components, for example, fruit juice.

Thickeners

One or more thickeners may be optionally added to the present compositions to, for example, provide viscosity control. Preferred thickening agents include natural and synthetic hums, and natural and chemically modified starches. Suitable gums include locust bean gum, guar gum, gellan gum, xanthan gum, gum ghatti, modified gum ghatti, tragacanth gum, carrageenan, and anionic polyments derived from cellulose such as carboxymethylcellulose, sodium carboxymethylcellulose, as well as mixtures of these gums. Suitable starches include, but are not limited to, pregelatinized starch (e.g., corn, wheat, tapioca), pregelatinized high amylose content starch, pregelatinized hydrolyzed starches (e.g., maltodextrins, corn syrup solids), chemically modified starches such as pregelatinized substituted starches (e.g., octenyl succinate modified starches such as N-Creamer, N-Lite LP, and TEXTRA, manufactured by National Starch), as well as mixtures of these starches. It is particularly preferred that the thickening agent is predominantly made from starches and that no more than about 20%, most preferably no more than about 10%, of the thickener is made from gums.

Flavor Agents

The compositions herein may optionally, but preferably, comprise one or more flavor agents. Preferably, such flavor agents are included in the beverage compositions and are typically selected from dairy protein, fruit juice, fruit flavors, botanical flavors, and mixtures thereof.

As used herein, the term “dairy protein” is inclusive of all forms of milk (e.g., mammalian or vegetable source). Milk includes, but is not limited to, whole milk, skim milk, condensed milk, non-fat milk, creamers, and milk solids (all of which may be fat or non-fat). Preferably, wherein dairy protein is utilized, the composition comprises from about 0.01% to about 20%, more preferably from about 0.1% to about 15%, even more preferably from about 0.5% to about 10%, and most preferably from about 0.5% to about 5% of dairy protein, wherein the amounts are expressed in terms of milk solids, by weight of the composition.

Wherein fruit juice is included, the beverages of the present invention can comprise from about 0.1% to about 99%, preferably from about 1% to about 50%, more preferably from about 2% to about 15%, and most preferably from about 3% to about 6%, fruit juice. (As measured herein, the weight percentage of fruit juice is based on a single strength 2° to 16° Brix fruit juice). The fruit juice can be incorporated into the beverage as a puree, comminute, or as a single strength or concentrated juice. Especially preferred is incorporation of the fruit juice as a concentrate with a solids content (primarily as sugar solids) of from about 20° to about 80° Brix.

The fruit juice can be any citrus juice, non-citrus juice, or mixture thereof, which are known for use in dilute juice beverages. The juice can be derived from, for example, apple, cranberry, pear, peach, plum, apricot, nectarine, grape, cherry, currant, raspberry, gooseberry, elderberry, blackberry, blueberry, strawberry, lemon, lime, mandarin, orange, grapefruit, cupuacu, potato, tomato, lettuce, celery, spinach, cabbage, watercress, dandelion, rhubarb, carrot, beet, cucumber, pineapple, coconut, pomegranate, kiwi, mango, papaya, banana, watermelon, passion fruit, tangerine, and cantaloupe. Preferred juices are derived from apple, pear, lemon, lime, mandarin, grapefruit, cranberry, orange, strawberry, tangerine, grape, kiwi, pineapple, passion fruit, mango, guava, raspberry and cherry. Citrus juices, preferably grapefruit, orange, lemon, lime, and mandarin juices, as well as juices derived from mango, apple, passion fruit, and guava, as well as mixtures of these juices are most preferred.

Fruit flavors may also be utilized. Fruit flavors may be derived from natural sources such as essential oil and extracts, or can be synthetically prepared. Fruit flavors may be derived from fruits through processing, particularly concentrating. Wherein fruit juices are concentrated or evaporated, the water which is removed or the condensate contains volatile substances which comprise the flavor of the fruit. Often, such flavor is added to a juice concentrate to enhance the flavor thereof. The condensate may also be used to flavor “near waters” (lightly flavored water).

Botanical flavors may also be utilized including those derived from the beans, nuts, bark, roots, and/ or leaves of a plant. Botanical flavors can be derived from natural sources such as essential oils and extracts, or can be synthetically prepared. Highly preferred botanical flavors include tea and coffee, particularly coffee. Other suitable botanical flavors include jamaica, kola, marigold, chrysanthemum, chamomile, ginger, valerian, yohimbe, hops, eriodictyon, ginseng, bilberry, rice, red wine, mango, peony, lemon balm, nut gall, oak chip, lavender, walnut, gentiam, luo han guo, cinnamon, angelica, aloe, agrimony, yarrow and mixtures thereof.

Wherein tea solids are included, the beverages of the present invention can comprise from about 0.01% to about 1.2%, preferably from about 0.05% to about 0.8%, by weight of the beverage product, of tea solids. The term “tea solids” as used herein means solids extracted from tea materials including those materials obtained from the genus Camellia including C. sinensis and C. assaimica, for instance, freshly gathered tea leaves, fresh green tea leaves that are dried immediately after gathering, fresh green tea leaves that have been heat treated before drying to inactivate any enzymes present, unfermented tea, instant green tea, and partially fermented tea leaves. Green tea solids are tea leaves, tea plant stems, and other plant materials that are related and which have not undergone substantial fermentation to create black teas. Members of the genus Phyllanthus, Catechu gambir and Uncaria family of tea plants can also be used. Mixtures of unfermented and partially fermented teas can be used.

As is commonly known in the art, coffee may be derived from a variety of forms, including roast ground coffee and instant coffee. The coffee bean utilized may be any of a variety of available coffee beans. As non-limiting examples, Brazilian, natural Arabica, washed Arabica, and Robusta varieties may be used.

Tea solids for use in beverages of the present invention can be obtained by known and conventional tea solid extraction methods. A particularly preferred source of green tea solids can be obtained by the method described in Ekanayake et al., U.S. application Ser. No. 08/606,907, filed Feb. 26, 1996. Tea solids so obtained will typically comprise caffeine, theobromine, proteins, amino acids, minerals and carbohydrates. Suitable beverages containing tea solids can be formulated according to Tsai et al., U.S. Pat. No. 4,946,701, issued Aug. 7, 1990. See also, Ekanayake et al., U.S. Pat. No. 5,427,806, issued Jun. 26, 1995, for suitable sources of green tea solids for use in the present invention.

Sweeteners

The beverage compositions of the present invention can, and typically will, contain an effective amount of one or more sweeteners, including carbohydrate sweeteners and natural and/or artificial no/low calorie sweeteners. The amount of the sweetener used in the compositions of the present invention typically depends upon the particular sweetener used and the sweetness intensity desired. For no/low calorie sweeteners, this amount varies depending upon the sweetness intensity of the particular sweetener.

The compositions of the present invention can be sweetened with any of the carbohydrate sweeteners, preferably monosaccharides and/or disaccharides. Sweetened compositions, particularly beverages, will typically comprise from about 0.1% to about 40%, more preferably from about 0.1% to about 20%, and most preferably from about 6 to about 14%, sweetener. These sweeteners can be incorporated into the compositions in solid or liquid form but are typically, and preferably, incorporated as a syrup, most preferably as a concentrated syrup such as high fructose corn syrup. For purposes of preparing beverages of the present invention, these sugar sweeteners can be provided to some extent by other components of the beverage such as, for example, the fruit juice component and/or flavors.

Preferred sugar sweeteners for use in compositions of the present invention are sucrose, fructose, glucose, and mixtures thereof. Fructose can be obtained or provided as liquid fructose, high fructose corn syrup, dry fructose or fructose syrup, but is preferably provided as high fructose corn syrup. High fructose corn syrup (HFCS) is commercially available as HFCS-42, HFCS-55 and HFCS-90, which comprise 42%, 55% and 90%, respectively, by weight of the sugar solids therein, as fructose. Other naturally occurring sweeteners or their purified extracts, such as glycyrrhizin, the protein sweetener thaumatin, the juice of Luo Han Guo disclosed in, for example, Fischer et al., U.S. Pat. No. 5,433,965, issued Jul. 18, 1995, and the like can also be used in the compositions of the present invention.

Suitable no/low calorie sweeteners include saccharin, cyclamates, L-aspartyl-L-phenylalanine lower alkyl ester sweeteners (e.g., aspartame); L-aspartyl-D-alanine amides disclosed in Brennan et al., U.S. Pat. No. 4,411,925; L-aspartyl-D-serine amides disclosed in Brennan et al., U.S. Pat. No. 4,399,163; L-aspartyl-L-1-hydroxymethylalkaneamide sweeteners disclosed in Brand, U.S. Pat. No. 4,338,346; L-aspartyl-1-hydroxyethyalkaneamide sweeteners disclosed in Rizzi, U.S. Pat. No. 4,423,029; L-aspartyl-D-phenylglycine ester and amide sweeteners disclosed in Janusz, European Patent Application 168,112, published Jan. 15, 1986; N-[N-3,3-dimethylbutyl)-L-alpha-aspartyl]-L-phenylalanine 1-methyl ester sweeteners disclosed in Gerlat et al., WO 99/30576, assigned to The Nutrasweet Co., published Jun. 24, 1999; alltame, thaumatin; dihydrochalcones; cyclamates; steviosides; glycyrrhizins, synthetic alkoxy aromatics, such as Dulcin and P-4000; sucralose; suosan; miraculin; monellin; sorbitol, xylitol; cyclohexylsulfamates; substituted imidazolines; synthetic sulfamic acids such as acesulfame, acesulfame-K and n-substituted sulfamic acids; oximes such as perilartine; rebaudioside-A; peptides such as aspartyl malonates and succanilic acids; dipeptides; amino acid based sweeteners such as gem-diaminoalkanes, meta-aminobenzoic acid, L-aminodicarboxylic acid alkanes, and amides of certain alpha-aminodicarboxylic acids and gem-diamines; and 3-hydroxy-4-alkyloxyphenyl aliphatic carboxylates or heterocyclic aromatic carboxylates; and the like and mixtures thereof. A particularly preferred low calorie sweetener is aspartame.

Coloring Agent

Small amounts of coloring agents may be utilized in the compositions of the present invention. Natural and artificial colors may be used.

FD&C dyes (e.g., yellow #5, blue #2, red #40) and/or FD&C lakes are preferably used. By adding the lake or dye to the other powdered ingredients, all the particles, in particular the colored iron compound, are completely and uniformly colored and a uniformly colored composition is attained. Preferred lakes which may be used in the present invention are the FDA-approved Lake, such as Lake red #40, yellow #6, blue #1, and the like. Additionally, a mixture of FD&C dyes or a FD&C lake dye in combination with other conventional colorants may be used.

Other coloring agents, for example, natural agents may be utilized. Non-limiting examples of such other coloring agents include fruit and vegetable juices, riboflavin, carotenoids (e.g., beta-carotene), tumeric, and lycopenes.

The exact amount of coloring agent used will vary, depending on the agents used and the intensity desired in the finished product. Generally, if utilized, the coloring agent should be present at a level of from about 0.0001% to about 0.5%, preferably from about 0.001% to about 0.1%, and most preferably from about 0.004% to about 0.1%, by weight of the composition.

Nutrients

The compositions herein may optionally be fortified with one or more nutrients, including one or more vitamins and/or minerals. The U.S. Recommended Daily Intake (USRDI) for vitamins and minerals is defined and set forth in the Recommended Daily Dietary Allowance-Food and Nutrition Board, National Academy of Sciences-National Research Council. Unless otherwise specified herein, wherein a given vitamin is present in the composition, the composition comprises at least about 1%, preferably at least about 5%, more preferably from about 10% to about 200%, even more preferably from about 20% to about 150%, and most preferably from about 25% to about 120% of the USRDI of such vitamin.

Non-limiting examples of vitamins include vitamin A, one or more B-complex vitamins (which include one or more of thiamine (also commonly referred to as “vitamin B₁”), riboflavin (also commonly referred to as “vitamin B₂”), niacin (also commonly referred to as “vitamin B₃”), pantothenic acid (also commonly referred to as “vitamin B₅”), pyridoxine (also commonly referred to as “vitamin B₆”), biotin, folic acid (also commonly referred to as folate), and the cobalamins (also commonly referred to as “vitamin B₁₂”)), vitamin C, vitamin D, and vitamin E. Preferably, wherein a vitamin is utilized the vitamin or mineral is selected from vitamin A, niacin, thiamine, folic acid, pyroxidine, pantothenic acid, vitamin C, vitamin E, and vitamin D. Preferably, at least one vitamin is selected from vitamin A, thiamine, pyroxidine, pantothenic acid, vitamin C, and vitamin E.

As used herein, “vitamin A” is inclusive of one or more nutritionally active unsaturated hydrocarbons, including the retinoids (a class of compounds including retinol and its chemical derivatives having four isoprenoid units) and the carotenoids.

Common retinoids include retinol, retinal, retinoic acid, retinyl palmitate, and retinyl acetate.

In a preferred embodiment herein, the vitamin A is a carotenoid. Common carotenoids include beta-carotene, alpha-carotene, beta-apo-8′-carotenal, cryptoxanthin, canthaxanthin, astacene, and lycopene. Among these, beta-carotene is the most preferred for use herein.

The vitamin A may be in any form, for example, an oil, beadlets, or encapsulated. See e.g., Cox et al., U.S. Pat. No. 6,007,856, assigned to The Procter & Gamble Co., issued Dec. 28, 1999. Vitamin A is often available as an oil dispersion, i.e., small particles suspended in oil.

Wherein vitamin A is present in the compositions herein, the composition typically comprises, per single serving of the composition (typically, about 240 milliliters of total composition), at least about 1%, preferably at least about 5%, more preferably from about 10% to about 200%, even more preferably from about 15% to about 150%, and most preferably from about 20% to about 120% of the USRDI of such vitamin. Wherein vitamin A is present in the compositions herein, it is especially preferred to include about 25% of the USRDI of vitamin A, per single serving of the composition. Alternatively, the compositions preferably comprise from 0% to about 1%, more preferably from about 0.0002% to about 0.5%, also preferably from about 0.0003% to about 0.25%, even more preferably from about 0.0005% to about 0.1%, and most preferably from about 0.001% to about 0.08% of vitamin A, by weight of the composition. The ordinarily skilled artisan will understand that the quantity of vitamin A to be added is dependent on processing conditions and the amount of vitamin A delivery desired after storage.

As stated the vitamin used herein may be a B-complex vitamin. As used herein, the B-complex vitamins include one or more of thiamine (also commonly referred to as “vitamin B₁”), riboflavin (also commonly referred to as “vitamin B₂”), niacin (also commonly referred to as “vitamin B₃”), pantothenic acid (also commonly referred to as “vitamin B₅”), pyridoxine (also commonly referred to as “vitamin B₆”), biotin, folic acid (also commonly referred to as folate), and the cobalamins (also commonly referred to as “vitamin B₁₂”). Among these, inclusion of vitamin B₁ and/or B₆ are particularly preferred.

Wherein a B-complex vitamin is present in the compositions herein, the composition typically comprises at least about 1%, preferably at least about 5%, more preferably from about 10% to about 200%, even more preferably from about 15% to about 150%, and most preferably from about 20% to about 120% of the USRDI of each B-complex vitamin present in the composition, per single serving of the composition (typically, about 240 milliliters of total composition). Wherein a B-complex vitamin is present in the compositions herein, it is especially preferred to include from about 10% to about 50% of the USRDI of each B-complex vitamin present in the composition, per single serving of the composition. Alternatively, wherein a B-complex vitamin is included within the present compositions, the compositions typically comprise from 0% to about 2%, more preferably from about 0.0002% to about 1%, also preferably from about 0.0005% to about 0.2%, even more preferably from about 0.001% to about 0.1%, and most preferably from about 0.001% to about 0.1% of each B-complex vitamin present in the composition, by weight of the composition. The ordinarily skilled artisan will understand that the quantity of B-complex vitamin to be added is dependent on processing conditions and the amount of B-complex vitamin delivery desired after storage.

As used herein, “vitamin C” is inclusive of one or more of L-ascorbic acid, as well as their bioequivalent forms including salts and esters thereof. For example, the sodium salt of L-ascorbic acid is considered vitamin C herein. Additionally, there are many widely known esters of vitamin C, including ascorbyl acetate. Fatty acid esters of vitamin C are lipid soluble and can provide an antioxidative effect.

The vitamin C utilized may be in any form, for example, free or in encapsulated form.

Wherein vitamin C is present in the compositions herein, the composition typically comprises at least about 1%, preferably at least about 5%, more preferably from about 10% to about 200%, even more preferably from about 15% to about 150%, and most preferably from about 20% to about 120% of the USRDI of such vitamin, per single serving of the composition (typically, about 240 milliliters of total composition). Wherein vitamin C is present in the compositions herein, it is especially preferred to include about 100% of the USRDI of vitamin C, per single serving of the composition. Alternatively, wherein vitamin C is included within the present compositions, the compositions typically comprise from 0% to about 2%, more preferably from about 0.0002% to about 1%, also preferably from about 0.0003% to about 0.5%, even more preferably from about 0.0005% to about 0.2%, and most preferably from about 0.001% to about 0.1% of vitamin C, by weight of the composition. The ordinarily skilled artisan will understand that the quantity of vitamin C to be added is dependent on processing conditions and the amount of vitamin C delivery desired after storage.

As used herein, “vitamin E” is inclusive of one or more tocols or tocotrienols which exhibit vitamin activity similar to that of alpha-tocopherol (which, as used herein, is considered a tocol) as well as their bioequivalent forms including salts and esters thereof. Vitamin E is typically found in oils including, for example, sunflower, peanut, soybean, cottonseed, corn, olive, and palm oils.

Non-limiting examples of vitamin E include alpha-tocopherol, beta-tocopherol, gamma-tocopherol, and delta-tocopherol, as well as esters thereof (e.g., alpha-tocopherol acetate). Alpha-tocopherol and particularly alpha-tocopherol acetate are highly preferred for use as vitamin E herein.

The vitamin E utilized may be in any form, for example, free or in encapsulated form. Wherein vitamin E is present in the compositions herein, the composition typically comprises at least about 1%, preferably at least about 5%, more preferably from about 10% to about 200%, even more preferably from about 15% to about 150%, and most preferably from about 20% to about 120% of the USRDI of such vitamin, per single serving of the composition (typically, about 240 milliliters of total composition). Wherein vitamin E is present in the compositions herein, it is especially preferred to include about 25% of the USRDI of vitamin E, per single serving of the composition. Alternatively, wherein vitamin E is included within the present compositions, the compositions typically comprise from 0% to about 2%, more preferably from about 0.0002% to about 1%, also preferably from about 0.0003% to about 0.2%, even more preferably from about 0.0005% to about 0.1%, and most preferably from about 0.001% to about 0.1% of vitamin E, by weight of the composition. The ordinarily skilled artisan will understand that the quantity of vitamin E to be added is dependent on processing conditions and the amount of vitamin E delivery desired after storage.

Minerals are well-known in the art. Non-limiting examples of such minerals include zinc, iron, magnesium, calcium, selenium, iodine, and fluoride. Preferably, wherein a mineral is utilized, the mineral is selected from zinc, magnesium, iron, iodine, and calcium. Most preferably, the mineral is selected from zinc, iron, magnesium, and calcium. Iron and calcium are particularly preferred for use herein. Minerals may be, for example, salts, chelated, complexed, encapsulated, or in colloidal form.

As used herein, “zinc” is inclusive of any compound containing zinc, including a salt, complex, or other form of zinc, including elemental zinc. Acceptable forms of zinc are well-known in the art. The zinc which can be used in the present invention can be in any of the commonly used forms such as, e.g., zinc lactate, zinc sulfate, zinc chloride, zinc acetate, zinc gluconate, zinc ascorbate, zinc citrate, zinc aspartate, zinc picolinate, amino acid chelated zinc, and zinc oxide. Zinc gluconate and amino acid chelated zinc are particularly preferred. Additionally, it has been found that amino acid chelated zinc is most highly preferred, as this zinc form provides optimized bioavailability of the zinc, other minerals present within the composition, as well as optimizing the bioavailability of the arabinogalactan utilized in the composition.

Amino acid chelates of zinc are well-known in the art, and are described in, for example, Pedersen et al., U.S. Pat. No. 5,516,925, assigned to Albion International, Inc., issued May 14, 1996; Ashmead, U.S. Pat. No. 5,292,729, assigned to Albion International, Inc., issued Mar. 8, 1994; and Ashmead, U.S. Pat. No. 4,830,716, assigned to Albion International, Inc., issued May 16, 1989.

Additionally, encapsulated zinc is also preferred for use herein. For example, the zinc may be encapsulated with bilayer-forming emulsifiers. See Mehansho et al., U.S. Pat. No. 5,888,563, issued Mar. 30, 1999.

Zinc fortified compositions of the present invention typically contain at least about 1 milligram of zinc, more preferably at least about 5 milligrams of zinc, and most preferably at least about 10 milligrams of zinc, all per single serving of the composition (typically, about 240 milliliters of total composition). Typically, from about 10 milligrams to about 25 milligrams of zinc per single serving is recommended. Alternatively, the present compositions preferably comprise from 0% to about 0.1% zinc, more preferably from about 0.001% to about 0.08% zinc, even more preferably from about 0.002% to about 0.05% zinc, and most preferably from about 0.002% to about 0.03% zinc, by weight of the composition. As used herein, recitations of mass or weight percent of zinc in any given composition refers to the mass or weight percent of the zinc-containing component (for example, the amino acid chelated zinc component), rather than the mass or weight percent of the elemental zinc which is part of the zinc-containing component. Of course, wherein elemental zinc is utilized as the zinc, the mass or weight percent of zinc in any given composition refers to that of the elemental zinc.

As used herein, “iron” is inclusive of any compound containing iron, including a salt, complex, or other form of iron, including elemental iron. Acceptable forms of iron are well-known in the art.

Non-limiting examples of ferrous iron sources which can be used in the present invention include ferrous sulfate, ferrous fumarate, ferrous succinate, ferrous gluconate, ferrous lactate, ferrous tartrate, ferrous citrate, ferrous amino acid chelates, and ferrous pyrophsophate, as well as mixtures of these ferrous salts. While ferrous iron is typically more bioavailable, certain ferric salts can also provide highly bioavailable sources of iron. Non-limiting examples of ferric iron sources that can be used in the present invention are ferric saccharate, ferric ammonium citrate, ferric citrate, ferric sulfate, ferric chloride, and ferric pyrophosphate, as well as mixtures of these ferric salts. A particularly preferred ferric iron source is ferric pyrophosphate, for example, microencapsulated SUNACTIVE Iron, commercially available from Taiyo International, Inc., Edina, Minnesota, U.S.A. and Yokkaichi, Mie, Japan. SUNACTIVE Iron is particularly preferred for use herein due to its water-dispersibility, particle size, compatibility, and bioavailability.

Ferrous amino acid chelates particularly suitable as highly bioavailable amino acid chelated irons for use in the present invention are those having a ligand to metal ratio of at least 2:1. For example, suitable ferrous amino acid chelates having a ligand to metal mole ratio of two are those of formula:

Fe(L)₂

where L is an alpha amino acid, dipeptide, tripeptide or quadrapeptide reacting ligand. Thus, L can be any reacting ligand that is a naturally occurring alpha amino acid selected from alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine and valine or dipeptides, tripeptides or quadrapeptides formed by any combination of these amino acids. See e.g., Pedersen et al., U.S. Pat. No. 5,516,925, assigned to Albion International, Inc., issued May 14, 1996; Ashmead, U.S. Pat. No. 5,292,729, assigned to Albion International, Inc., issued Mar. 8, 1994; and Ashmead, U.S. Pat. No. 4,830,716, assigned to Albion International, Inc., issued May 16, 1989. Particularly preferred ferrous amino acid chelates are those where the reacting ligands are glycine, lysine, and leucine. Most preferred is the ferrous amino acid chelate sold under the trade name FERROCHEL having the reacting ligand as glycine. FERROCHEL is commercially available from Albion Laboratories, Salt Lake City, Utah.

In addition to these highly bioavailable ferrous and ferric salts, other sources of bioavailable iron can be included in the compositions of the present invention. Other sources of iron particularly suitable for fortifying compositions herein certain iron-sugar-carboxylate complexes. In these iron-sugar-carboxylate complexes, the carboxylate provides the counterion for the ferrous (preferred) or ferric iron. The overall synthesis of these iron-sugar-carboxylate complexes involves the formation of a calcium-sugar moiety in aqueous media (for example, by reacting calcium hydroxide with a sugar, reacting the iron source (such as ferrous ammonium sulfate) with the calcium-sugar moiety in aqueous media to provide an iron-sugar moiety, and neutralizing the reaction system with a carboxylic acid (the “carboxylate counterion”) to provide the desired iron-sugar-carboxylate complex). Sugars that can be used to prepare the calcium-sugar moiety include any of the ingestible saccharidic materials, and mixtures thereof, such as glucose, sucrose and fructose, mannose, galactose, lactose, maltose, and the like, with sucrose and fructose being the more preferred. The carboxylic acid providing the “carboxylate counterion” can be any ingestible carboxylic acid such as citric acid, malic acid, tartaric acid, lactic acid, succinic acid, and propionic acid, as well as mixtures of these acids.

Additionally, encapsulated iron is also preferred for use herein. For example, ferrous sulfate encapsulated in a hydrogenated soybean oil matrix may be used, for example CAP-SHUR , which is commercially available from Balchem Corp., Slate Hill, N.Y. Other solid fats can be used to encapsulate the iron, such as, tristearin, hydrogenated corn oil, cottonseed oil, sunflower oil, tallow, and lard. A particularly preferred encapsulated iron source is microencapsulated SUNACTIVE Iron, commercially available from Taiyo International, Inc., Edina, Minn., U.S.A. SUNACTIVE Iron is particularly preferred for use herein due to its water-dispersibility and bioavailability. Additionally, the iron (particularly, ferrous fumarate and ferrous succinate) may be encapsulated with bilayer-forming emulsifiers. See Mehansho et al., U.S. Pat. No. 5,888,563, issued Mar. 30, 1999.

Iron fortified compositions of the present invention preferably contain at least about 1 milligram of iron, more preferably at least about 5 milligrams of iron, and most preferably at least about 10 milligrams of iron all per single serving of the composition (typically, about 240 milliliters of total composition). Typically, from about 10 milligrams to about 25 milligrams of iron is recommended per single serving. Alternatively, the present compositions comprise from 0% to about 0.1% iron, more preferably from about 0.0001% to about 0.08% iron, even more preferably from about 0.0002% to about 0.05% iron, and most preferably from about 0.0002% to about 0.03% iron, by weight of the composition. As used herein, recitations of mass or weight percent of “iron” in any given composition refers to the mass or weight percent of the iron-containing component (for example, the amino acid chelated iron component), rather than the mass or weight percent of the elemental iron which is part of the iron-containing component. Of course, wherein elemental iron is utilized as the “iron”, the mass or weight percent of iron in any given composition refers to that of the elemental iron.

As used herein, “magnesium” is inclusive of any compound containing magnesium, including a salt, complex, or other form of magnesium, including elemental magnesium. Acceptable forms of magnesium are well-known in the art.

Magnesium chloride, magnesium citrate, magnesium gluceptate, magnesium gluconate, magnesium hydroxide, magnesium lactate, magnesium oxide, magnesium picolate, and magnesium sulfate are non-limiting, exemplary forms of magnesium for use herein. Additionally, amino acid chelated and creatine chelated magnesium are highly preferred. Amino acid and creatine chelates of magnesium are well-known in the art, and are described in, for example, Pedersen et al., U.S. Pat. No. 5,516,925, issued May 14, 1996; Ashmead, U.S. Pat. No. 5,292,729, issued Mar. 8, 1994; and Ashmead, U.S. Pat. No. 4,830,716, issued May 16, 1989. These chelates contain one or more natural amino acids selected from alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine and valine or dipeptides, tripeptides or quadrapeptides formed by any combination of these amino acids.

Typically, wherein magnesium is utilized herein, at least about 1 milligram of magnesium is included per single serving of the composition (typically, about 240 milliliters of total composition). More preferably, when used, at least about 50 milligrams of magnesium is included per single serving of the composition. Most preferably, when used, at least about 100 milligrams of magnesium is included per single serving of the composition. About 400 milligrams of magnesium, per single serving of the composition, is recommended for adult humans. Alternatively, the present compositions comprise from 0% to about 1% magnesium, more preferably from about 0.001% to about 0.8% magnesium, even more preferably from about 0.002% to about 0.6% magnesium, and most preferably from about 0.002% to about 0.5% magnesium, by weight of the composition. As used herein, recitations of mass or weight percent of “magnesium” in any given composition refers to the mass or weight percent of the magnesium-containing component (for example, the amino acid chelated magnesium component), rather than the mass or weight percent of the elemental magnesium which is part of the magnesium-containing component. Of course, wherein elemental magnesium is utilized as the “magnesium”, the mass or weight percent of magnesium in any given composition refers to that of the elemental magnesium.

As used herein, “calcium” is inclusive of any compound containing calcium, including a salt, complex, or other form of calcium, including elemental calcium. Acceptable forms of calcium are well-known in the art.

Preferred sources of calcium include, for example, amino acid chelated calcium, calcium carbonate, calcium oxide, calcium hydroxide, calcium sulfate, calcium chloride, calcium phosphate, calcium hydrogen phosphate, calcium dihydrogen phosphate, calcium citrate, calcium malate, calcium titrate, calcium gluconate, calcium realate, calcium tantrate, and calcium lactate, and in particular calcium citrate malate. The form of calcium citrate malate is described in, e.g., Mehansho et al., U.S. Pat. No. 5,670,344, issued Sep. 23, 1997; Diehl et al., U.S. Pat. No. 5,612,026, issued Mar. 18, 1997; Andon et al., U.S. Pat. No. 5,571,441, issued Nov. 5, 1996; Meyer et al., U.S. Pat. No. 5,474,793, issued Dec. 12, 1995; Andon et al., U.S. Pat. No. 5,468,506, issued Nov. 21, 1995; Burkes et al., U.S. Pat. No. 5,445,837, issued Aug. 29, 1995; Dake et al., U.S. Pat. No. 5,424,082, issued Jun. 13, 1995; Burkes et al., U.S. Pat. No. 5,422,128, issued Jun. 6, 1995; Burkes et al., U.S. Pat. No. 5,401,524, issued Mar. 28, 1995; Zuniga et al., U.S. Pat. No. 5,389,387, issued Feb. 14, 1995; Jacobs, U.S. Pat. No. 5,314,919, issued May 24, 1994; Saltman et al., U.S. Pat. No. 5,232,709, issued Aug. 3, 1993; Camden et al., U.S. Pat. No. 5,225,221, issued Jul. 6, 1993; Fox et al., U.S. Pat. No. 5,215,769, issued Jun. 1, 1993; Fox et al., U.S. Pat. No. 5,186,965, issued Feb. 16, 1993; Saltman et al., U.S. Pat. No. 5,151,274, issued Sep. 29, 1992; Kochanowski, U.S. Pat. No. 5,128,374, issued Jul. 7, 1992; Mehansho et al., U.S. Pat. No. 5,118,513, issued Jun. 2, 1992; Andon et al., U.S. Pat. No. 5,108,761, issued Apr. 28, 1992; Mehansho et al., U.S. Pat. No. 4,994,283, issued Feb. 19, 1991; Nakel et al., U.S. Pat. No. 4,786,510, issued Nov. 22, 1988; and Nakel et al., U.S. Pat. No. 4,737,375, issued Apr. 12, 1988.

Typically, wherein calcium is utilized herein, at least about 100 milligrams of calcium is included, per single serving of the composition (typically, about 240 milliliters of total composition). More preferably, when used, at least about 200 milligrams of calcium is included per single serving of the composition. Most preferably, when used, at least about 400 milligrams of calcium is included per single serving of the composition. About 1,000 milligrams of calcium, per single serving of the composition, is recommended for adult humans. Preferred compositions of the present invention will comprise from 0% to about 5% calcium, more preferably from about 0.01% to about 0.5% calcium, still more preferably from about 0.03% to about 0.2% calcium, even more preferably from about 0.05% to about 0.15% calcium, and most preferably from about 0.1% to about 0.15% calcium, by weight of the composition. As used herein, recitations of mass or weight percent of “calcium” in any given composition refers to the mass or weight percent of the calcium-containing component (for example, the amino acid chelated calcium component), rather than the mass or weight percent of the elemental calcium which is part of the calcium-containing component. Of course, wherein elemental calcium is utilized as the “calcium”, the mass or weight percent of calcium in any given composition refers to that of the elemental calcium.

As used herein, “iodine” is inclusive of any compound containing iodine, including a salt, complex, or other form of iodine, including elemental iodine. Acceptable forms of iodine are well-known in the art. Non-limiting examples of iodine forms include potassium iodide, sodium iodide, potassium iodate, and sodium iodate.

Typically, wherein iodine is utilized herein, at least about 10 micrograms of iodine is included, per single serving of the composition (typically, about 240 milliliters of total composition). More preferably, when used, at least about 15 micrograms of iodine is included, per single serving of the composition. Most preferably, when used, at least about 20 micrograms of iodine is included, per single serving of the composition. From about 10 to about 70 micrograms of iodine, per single serving of the composition, is recommended for adult humans. Preferred compositions of the present invention will comprise from 0% to about 0.1% iodine, more preferably from about 0.00001% to about 0.05% iodine, still more preferably from about 0.00001% to about 0.01% iodine, even more preferably 0.00001% to about 0.005% iodine, and most preferably from about 0.00001% to about 0.001% iodine, by weight of the composition. As used herein, recitations of mass or weight percent of “iodine” in any given composition refers to the mass or weight percent of the iodine-containing component (for example, potassium iodide), rather than the mass or weight percent of the elemental iodine which is part of the iodine-containing component. Of course, wherein elemental iodine is utilized as the “iodine”, the mass or weight percent of iodine in any given composition refers to that of the elemental iodine.

Fiber

Compositions can be made which further comprise one or more dietary fibers. By “dietary fiber” is meant complex carbohydrates resistant to digestion by mammalian enzymes, such as the carbohydrates found in plant cell walls and seaweed, and those produced by microbial fermentation. Examples of these complex carbohydrates are brans, celluloses, hemicelluloses, pectins, gums and mucilages, seaweed extract, and biosynthetic gums. Sources of the cellulosic fiber include vegetables, fruits, seeds, cereals, and man-made fibers (for example, by bacterial synthesis). Commercial fibers such as purified plant cellulose, or cellulose flour, can also be used. Naturally occurring fibers include fiber from whole citrus peel, citrus albedo, sugar beets, citrus pulp and vesicle solids, apples, apricots, and watermelon rinds.

Particularly preferred fibers for use herein are glucose polymers, preferably those which have branched chains, and which are typically less digestible relative to starches and maltodextrins. Preferred among these fibers is one marketed under the trade name Fibersol2, commercially available from Matsutani Chemical Industry Co., Itami City, Hyogo, Japan.

Fructo-oligosaccharides are also preferred fibers herein. The preferred fructo-oligosaccharides are a mixture of fructo-oligosaccharides composed of a chain of fructose molecules linked to a molecule of sucrose. Most preferably, they have a nystose to kestose to fructosyl-nystose ratio of about 40:50:10, by weight of the composition. Preferred fructo-oligosaccharides may be obtained by enzymatic action of fructosyltransferase on sucrose such as those which are, for example, commercially available from Beghin-Meiji Industries, Neuilly-sur-Seine, France.

Other preferred fibers for use herein include arabinogalactans. Non-limiting examples of preferred, commercially available sources of arabinogalactan include LAREX UF, LARACARE A200, IMMUNEHANCER (CAS No. 9036-66-2), CLEARTRAC, FIBERAID, and AC-9, all commercially available from (for example) Larex, Inc. of St. Paul, Minn., U.S.A.

These dietary fibers may be in a crude or purified form. The dietary fiber used may be of a single type (e.g., cellulose), a composite dietary fiber (e.g., citrus albedo fiber containing cellulose and pectin), or some combination of fibers (e.g., cellulose and a gum). The fibers can be processed by methods known to the art.

Wherein a soluble fiber is utilized, the desired total level of soluble dietary fiber for the present compositions of the present invention is from about 0.01% to about 15%, preferably from about 0.1% to about 5%, more preferably from about 0.1% to about 3%, and most preferably from about 0.2% to about 2%. The total amount of soluble dietary fiber includes any added soluble dietary fiber as well as any soluble dietary fiber naturally present in any other component of the present invention.

Carbonation Component

Carbon dioxide can be introduced into the water which is mixed with a beverage syrup or into the dilute beverage after dilution to achieve carbonation. The carbonated beverage can be placed into a container, such as a bottle or can, and then sealed. Any conventional carbonation methodology may be utilized to make carbonated beverage products of this invention. The amount of carbon dioxide introduced into the beverage will depend upon the particular flavor system utilized and the amount of carbonation desired.

This discussion of the composition uses, combinations, and benefits is not intended to be limiting or all-inclusive. It is contemplated that other similar uses and benefits can be found that will fall within the spirit and scope of this invention.

### EXAMPLES

The following are non-limiting examples of compositions used in accordance with the present invention. The following examples are provided to illustrate the invention and are not intended to limit the scope thereof in any manner.

### Example 1

A composition which is a soy protein dispersion is prepared in accordance with the present invention as follows. Two thousand (2000) grams of an aqueous dispersion comprising about 10% soy protein, by weight of the dispersion, is prepared by mixing 200 grams of soy protein isolate (Protein Technologies International, St. Louis, Mo.) and 1800 grams of distilled water. The aqueous dispersion is cooled to a temperature of 5° C. and this temperature is maintained throughout the entire process using an ice water bath. The aqueous dispersion is mixed with an IKA Ultra Turrax T50 high shear mixer (IKA Works, Inc., Wilmington, N.C.) operated at 4000 RPM. Food grade potassium hydroxide pellets are added slowly until the pH of the slurry reaches at least about 12; at this point the mixture has a transparent greenish color. The high shear mixer is increased to 7200 rpm and food grade phosphoric acid is added until the aqueous dispersion reaches a pH of about 7. The resulting soy protein dispersion comprises soy protein particles within the confines of the present invention and is stored under refrigeration conditions until further use.

### Example 2

A composition which is a soy protein dispersion in accordance with the present invention is prepared as follows. Two thousand (2000) grams of an aqueous dispersion comprising about 10% soy protein, by weight of the dispersion, is prepared by mixing 200 grams of soy protein isolate (Protein Technologies International, St. Louis, Mo.) and 1800 grams of distilled water. The aqueous dispersion is cooled to a temperature of 5° C. and this temperature is maintained throughout the entire process using an ice water bath. The aqueous dispersion is mixed with an IKA Ultra Turrax T50 high shear mixer (IKA Works, Inc., Wilmington, N.C.) operated at 4000 RPM. Food grade potassium hydroxide pellets are added slowly until the pH of the slurry reaches at least about 12; at this point the mixture has a transparent greenish color. The high shear mixer is increased to 7200 rpm and food grade phosphoric acid is added until the aqueous dispersion reaches a pH of about 7. The soy protein microparticle aqueous dispersion is then subjected to homogenization in an APV GAULIN homogenizer (APV, Wilmington, Mass.) operated at about 7000 psi in a single stage mode. The soy protein microparticle dispersion is stored under refrigeration conditions.

### Example 3

A substantially dry composition comprising soy protein particles having a mean particle size distribution of from about 5 microns is prepared as follows. A soy protein dispersion is prepared in accordance with Example 2 herein. The dispersion is dried in a spray dryer operated at conditions known to those ordinarily skilled in the art to obtain a flowable and dispersible powder. The powder may be further utilized as desired, for example, in the formulation of food or beverage compositions.

### Example 4

A composition which is a milk and soy beverage is prepared in accordance with the present invention as follows. One thousand (1000) grams of the beverage is prepared by mixing 947 grams of skim milk, 33 grams of the soy protein dispersion prepared in accordance with Example 3, and 20 grams of sucrose in a 2000 milliliter glass beaker. The components are mixed for about 15 seconds with a BRAUN hand mixer. The beverage is placed in several 237 milliliter PET bottles and stored under refrigeration conditions. This beverage contains about 6.25 grams of soy protein per 237 milliliter serving.

### Example 5

A flavored beverage composition is prepared in accordance with the present invention as follows. One thousand (1000) grams of a juice/soy protein beverage are prepared by mixing 330 grams of the soy protein dispersion prepared in accordance with Example 2, with 100 grams of orange juice, 55 grams of sucrose, 4 grams of flavorant; and 511 grams of water in a 2000 milliliter glass beaker. The components are mixed for about 15 seconds with a BRAUN hand mixer. The beverage is placed in several 237 milliliter PET bottles and stored under refrigeration conditions. This beverage contains about 6.25 grams of soy protein per 237 milliliter serving.

### Example 6

A healthy soy beverage is prepared from the following ingredients in the indicated amounts:

| | % by weight of |
|---|---|
| Ingredient | the composition |
| Soy Protein Dispersion prepared | 23 |
| in accordance with Example 2 | |
| Orange Juice | 20 |
| Glucosamine | 0.75 |
| Calcium Hydroxide | 0.16 |
| Malic acid | 0.14 |
| Citric Acid | 0.32 |
| Acesulfame K | 0.05 |
| Flavor Agent | 0.67 |
| Water | Quantum satis |

All of the ingredients are placed in a 2000 milliliter glass beaker and mixed for about 15 seconds with a BRAUN hand mixer. The beverage is placed in 343 milliliter PET bottles and stored under refrigeration conditions.

### Example 7

A coffee beverage is prepared as follows. One thousand (1000) grams of the beverage is prepared by mixing 420 grams of the soy protein dispersion prepared in accordance with Example 2 with 200 grams of a coffee extract (4.0% coffee solids), 60 grams of fructose and 320 grams of water in a 2000 milliliter glass beaker. The components are mixed for about 15 seconds with a BRAUN hand mixer. The beverage is placed in 343 milliliter PET bottles and stored under refrigeration conditions. This coffee beverage is a fat-free and lactose-free beverage.

### Example 8

A high protein content flavored beverage composition is prepared as follows. One thousand (1000) grams of the beverage is prepared by mixing 420 grams of the soy protein dispersion prepared in accordance with Example 2 with 530 grams of water, 50 grams of sucrose and 0.5 grams of flavorants in a 2000 milliliter glass beaker. The components are mixed for about 15 seconds with a BRAUN hand mixer. The beverage is placed in 343 milliliter PET bottles and stored under refrigeration conditions. This beverage contains about 12 grams of soy protein per 343 milliliter serving.

### Example No. 9

A foamable flavored instant coffee product (1000 grams) is prepared from the following ingredients in the indicated amounts:

| | % by Weight of |
|---|---|
| Ingredient | the Composition |
| Soy Protein Dispersion prepared | 56.32 |
| in accordance with Example 3 | |
| Microcrystalline cellulose | 18.76 |
| Instant coffee | 20 |
| Cocoa powder | 2 |
| Acesulfame K | 0.38 |
| Aspartame | 0.3 |
| Flavor Agent | 1.36 |
| Citric acid | 0.38 |
| Sodium bicarbonate | 0.50 |

All of the ingredients are placed in a Hobart mixer (Hobart Corp., Troy, Ohio) and mixed for 5 minutes to prepare an instant dry mix. A ready to drink beverage may then be prepared by mixing 9.8 grams of the dry mix with 240 milliliters of water at 82° C. This flavored coffee beverage is a fat-free, lactose-free, and sugar-free beverage.

What is claimed is:

1. A composition comprising soy protein particles having a mean particle size distribution of from about 0.1 to about 10 microns, wherein the composition is substantially free of fat.

2. The composition according to claim 1 comprising no more than about 15% soy protein by weight of the composition.

3. The composition according to claim 2 wherein the mean particle size distribution is from about 0.1 to about 7 microns.

4. The composition according to claim 3 which is a beverage composition further comprising a flavor agent selected from the group consisting of dairy protein, fruit juice, fruit flavors, botanical flavors, and mixtures thereof.

5. The composition according to claim 3 wherein the mean particle size distribution is from about 0.1 to about 5 microns.

6. The composition according to claim 3 having a pH from about 6 to about 8.

7. The composition according to claim 6 which is a ready to drink beverage composition comprising at least about 70% water, by weight of the composition.

8. The composition according to claim 4 having a pH of from about 2.5 to about 3.5.

9. The composition according to claim 8 wherein at least one of the components is fruit juice.

10. The composition according claim 3 which is substantially dry.

11. A composition comprising soy protein particles having a mean particle size distribution of from about 0.1 to about 10 microns; wherein the pH of the composition is from about 6 to about 8.

12. The composition according to claim 11 comprising no more than about 15% soy protein, by weight of the composition.

13. The composition according to claim 12 wherein the mean particle size distribution is from about 0.1 to about 7 microns.

14. The composition according to claim 13 which is a beverage composition further comprising a flavor agent selected from the group consisting of dairy protein, fruit juice, fruit flavors, botanical flavors, and mixtures thereof.

15. The composition according to claim 14 wherein the mean particle size distribution is from about 0.1 to about 7 microns.

16. A composition comprising soy protein particles having a mean particle size distribution of from about 0.1 to about 10 microns; wherein the pH of the composition is from about 2.5 to about 3.5.

17. The composition according to claim 16 comprising no more than about 15% soy protein, by weight of the composition.

18. The composition according to claim 17 wherein the mean particle size distribution is from about 0.1 to about 7 microns.

19. The composition according to claim 18 which is a beverage composition further comprising a flavor agent selected from the group consisting of dairy protein, fruit juice, fruit flavors, botanical flavors, and mixtures thereof.

20. The composition according to claim 19 wherein the mean particle size distribution is from about 0.1 to about 5 microns.

21. A process for producing a composition comprising soy protein particles, comprising the steps of:
a) providing a mixture of a soy protein and an aqueous liquid, wherein the pH of the mixture is at least about 11;
b) lowering the pH of the mixture to a pH of from about 6 to about 8 and applying mechanical energy to the mixture;
wherein when the pH of the mixture is greater than about 8 the temperature of the mixture is at about 20° C. or less; and wherein the soy protein particles have a mean particle size distribution of from about 0.1 to about 10 microns.

22. The process according to claim 21 wherein when the pH of the mixture is greater than about 8 the temperature of the mixture is about 15° C. or less and wherein the application of mechanical energy is constantly applied during the lowering of the pH of the mixture.

23. The process according to claim 22 wherein when the pH of the mixture is greater than about 8 the temperature of the mixture is about 10° C. or less.

24. The process according to claim 23 wherein the mechanical energy is selected from the group consisting of high shear mixing, homogenization, colloid milling and combinations thereof.

25. The process according to claim 24 wherein when the high shear mixing is utilized, the high shear mixing is applied to the mixture at a rate of from about 100,000 1/sec to about 750,000 1/sec.

26. The process according to claim 25 wherein when the homogenization is utilized, the homogenization is applied to the mixture in a single stage at a pressure of at least about 350 kg/cm².

27. The process according to claim 26 wherein when the homogenization is utilized, the homogenization is applied to the mixture in a dual stage at a pressure of less than about 420 kg/cm².

28. The process according to claim 27 wherein when colloid milling is utilized, the colloid milling is applied to the mixture with a gap of from about 1 micron to about 20 microns.

29. The process according to claim 28 comprising further combining a flavor agent selected from the group consisting of dairy protein, fruit juice, fruit flavors, botanical flavors, and mixtures thereof.

30. The process according to claim 29 where the mean particle size distribution is from about 0.1 to about 5 microns.

31. The process according to claim 30 wherein the composition is substantially free of fat.

32. The process according to claim 31 wherein the composition has a soy protein content of no more than about 15%, by weight of the composition.

33. The process according to claim 32 wherein the mechanical energy is a combination of high shear mixing and homogenization.

34. A composition comprising soy protein particles, produced by a process comprising the steps of:
a) providing a mixture of a soy protein and an aqueous liquid, wherein the pH of the mixture is at least about 11;
b) lowering the pH of the mixture to a pH of from about 6 to about 8 and applying mechanical energy to the mixture;
wherein when the pH of the mixture is greater than about 8 the temperature of the mixture is maintained at about 20° C. or less; and wherein the soy protein particles have a mean particle size distribution of from about 0.1 to about 10 microns.

35. The composition according to claim 34 wherein when the pH of the mixture is greater than about 8 the temperature of the mixture is about 15° C. or less and wherein the application of mechanical energy is constantly applied during the lowering of the pH of the mixture.

36. The composition produced by the process according to claim 35 wherein when the pH of the mixture is greater than about 8 the temperature of the mixture is about 10° C. or less.

37. The composition produced by the process according to claim 36 wherein the mechanical energy is selected from the group consisting of high shear mixing, homogenization, colloid milling and combinations thereof.

38. The composition produced by the process according to claim 37 comprising further combining a flavor agent selected from the group consisting of dairy protein, fruit juice, fruit flavors, botanical flavors, and mixtures thereof.

39. The composition produced by the process according to claim 38 wherein the composition is substantially free of fat.
